(19) United States
(12) Patent Application Publication
(10) Pub. No.: US 2024/0321242 A1
(43) Pub. Date: Sep. 26, 2024

(54) DRUM TRAINING TOOL

(71) Applicant: Norval Rose, Ware, MA (US)

(72) Inventor: Norval Rose, Ware, MA (US)

(21) Appl. No.: 18/611,302

(22) Filed: Mar. 20, 2024

Related U.S. Application Data
(60) Provisional application No. 63/491,174, filed on Mar. 20, 2023.

(51) Int. Cl. G10D 13/12

(52) U.S. Cl. CPC G10D 13/12

(57) ABSTRACT

A drum training device, embodied in a modified pair of drumsticks, configured to facilitate and expedite the training of hand and wrist muscles as targeted for the act of drumming. The device is equipped with mounts which are configured to receive weights which snap or screw into position. The weights themselves may be stacked atop one another to compound the weight present at a given mount. The weights are preferably cylindrical, each having the same mass and dimension. A total of three mounts are present on each drumstick, and are preferably disposed in a line, equidistant from proximal mounts on each drumstick.

### CONTINUITY

This application is a non-provisional patent application of provisional patent application No. 63/491,174, filed on Mar. 20, 2023, and priority is claimed thereto.

### FIELD OF THE PRESENT INVENTION

The present invention relates to the field of musical instruments, and more specifically relates to a drumming training tool configured to assist a drummer in endurance training, drum stick accuracy, drum stick speed, muscle control, and overall skill enhancement.

### BACKGROUND OF THE PRESENT INVENTION

Drummers often use bigger drumsticks having more weight than traditional drumsticks in order to build muscle strength in their wrists and hands. However, bigger drumsticks can disrupt the feel of playing drums when the drummer reverts to the use of standard-sized drumsticks. As a result, individuals may end up building skills of drumming in a disadvantageous manner which can impact their playing ability.

If there were a specially designed drumstick which could be equipped with customized weights, players could practice with heavier drumsticks to develop their skills, as one might with the use of bigger drumsticks, while maintaining the standard size and shape of the drumsticks with which they are used to playing. Such a specially designed drumstick would enable users to develop proficiency which will directly carryover to actual play with standard drumsticks, thereby encouraging users to maintain proper form without requiring use of oversized drumsticks that may impact their play upon return to standard drumsticks.

Thus, there is a need for a new form of training drumsticks. Such training drumsticks preferably serve as a tool to assist the player/user in the development of wrist and hand muscles, helping to form the muscle memory required to become a skilled player. Such a tool is preferably equipped with a means by which weighted cylinders may be affixed to the exterior of the drumstick, enabling players to easily add or remove weights to alter the overall weight of the drumsticks.

### SUMMARY OF THE INVENTION

The present invention is a drumming training tool configured to assist drummers in practicing their routine. As such, the present invention is a modified drumstick which is equipped with multiple mounts. The mounts are configured to receive weights which preferably snap or screw into the mounts. The weights enable users to customize the desired weight of the drumsticks. Players may opt to use more weight for heavier hand/wrist training sessions, and lighter weights for endurance.

The following brief and detailed descriptions of the drawings are provided to explain possible embodiments of the present invention but are not provided to limit the scope of the present invention as expressed herein this summary section.

### BRIEF DESCRIPTION OF DRAWINGS OF THE PRESENT INVENTION

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 shows a detailed diagram of the drumsticks of the present invention and their components.

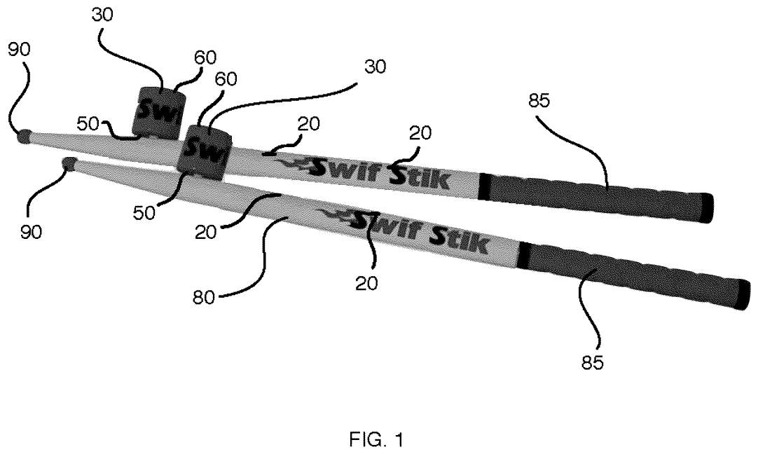

FIG. 2 depicts a drumstick of the present invention, detailing the mounts in a closer perspective.

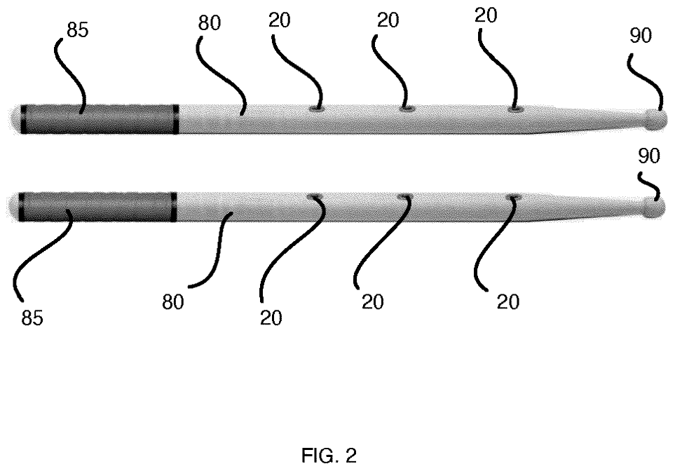

FIG. 3 shows an alternate embodiment of the drumstick of the present invention equipped with weights installed at three of the mounts, with an additional mount present, and with weights which vary in size and dimension, unlike the preferred embodiment.

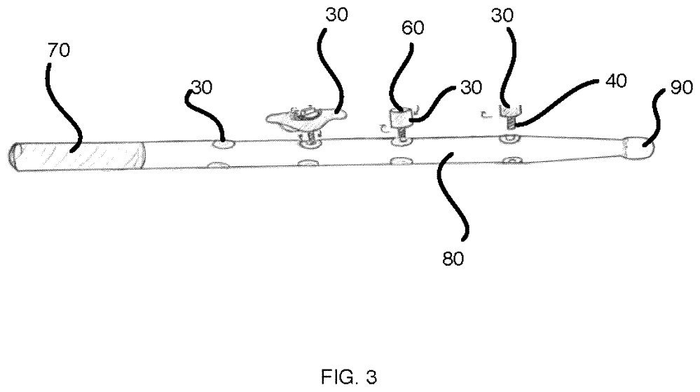

### DETAILED DESCRIPTION OF THE PRESENT INVENTION

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to affect such feature, structure, or characteristic in connection with other embodiments whether or not explicitly described.

The present invention is a drumming training tool and apparatus configured to facilitate the training of the art of drumming to a user. Users of the present invention are envisioned as both the novice (to develop skills) and/or the professional (to enhance their skills).

The present invention is embodied in a modified drumstick (10). The drumstick (10) is equipped with mounts (20) which are preferably disposed in a line such that each mount (20) is equidistant from the proximal mount (20). Alternate embodiments may exhibit the mounts (20) at varying distances from one another, but they are preferably all in a line on the same side of the drumstick (10). Preferred embodiments of the present invention exhibit a total of two mounts (20), one disposed at a midsection of a shaft (80) of the drumstick (10), and a second mount (20) disposed closer to a tip (90), just above a shoulder of the drumstick (10). A total of three mounts (20) are present along the drumstick (10) in some alternate embodiments of the present invention.

The mounts (20) are configured to accept weights (30) which snap into (or alternately screw into) the mounts via a peg (40) disposed on each weight (30). Each weight (30) is preferably uniform in weight, mass, and dimension. However, in alternate embodiments of the present invention, the weights (30) may exhibit differing shapes, including but not limited to a flat weight, a button weight, a high button weight, and/or a saddle-shaped weight.

The preferred embodiment of the weights (30) of the present invention are cylindrical, having the peg (40) disposed on a bottom (50) of each weight (30). Further, a mount (20), preferably identical to those within the drumstick (10), is present on a top (60) of each weight (30), which enables the weights (30) to be stacked atop one another by the user.

A handle (70) of the drumstick (10) preferably features an optional (removable) hand grip (85) which enables the user to maintain a firm, secure grip on each drumstick (10). The hand grip (85) is configured to slide over the handle similar to a sleeve and is held in place via tension and friction.

It should be noted that the drumstick (10) of the present invention is preferably sold in pairs, and users are advised to ensure the weights (30) added to each drumstick (10) are mirrored such that each of the drumsticks (10) maintains the same weight during play.

Further, as per conventional drumsticks, the present invention is equipped with a handle (70), shaft (80) (along which the mounts (30) are present), and the tip (90). It should be understood, per convention, that the present invention includes an identical pair (two) of modified drumsticks, and that they are envisioned for use together to strike drums, drum pads, cymbals, high hats, and other conventional drumming targets. Use of the present invention with added weights helps to train the hand, finger, and wrist muscles, ensuring they become stronger, leading to more proficient and enduring play sessions.

It should be noted that, for the training of a beginner in the art of drumming on a drum with drumsticks through use of the system and apparatus of the present invention, the beginner should first start with a single weight (20) disposed on the mount (30) located on the shaft (80), centrally disposed on the modified drumstick (10). This is because placing a weight (20) closer to the tip (90) makes drumming practice more challenging for the user.

As the player progresses in proficiency, the player may then move the weight (20) to the tip (90) for extra challenge. For further development of drumming skills of a professional, a weight (20) should be placed on the mount (30) closest to the tip (90) of the drumstick (10). If the player wishes to continue to challenge themselves, they should also add a weight (20) to the mount (30) disposed centrally on the shaft (80) of the drumstick (10). Alternately, the player may opt to stack a second weight (20) atop the first weight (20) (double-stacking) disposed on the mount (30) closest to the tip (90). It is not recommended for a player to place more than two weights on each drumstick (10), but each individual is more than free to push themselves with extra weights (20) if desired.

Additionally, it should be noted that a method by which a user may use the present invention to enhance or increase their proficiency in drumming is preferably as follows: grasping a first modified drumstick, the first modified drumstick equipped with a first mount, a second mount, and a third mount, each of which facilitate the attachment of weights; attaching a first weight to the first mount of the first modified drumstick, thereby increasing the overall weight of the first modified drumstick; grasping a second modified drumstick, the second modified drumstick being identical to the first modified drumstick, similarly having a first mount, second mount and third mount to facilitate the attachment of weights; attaching a second weight to the first mount of the second modified drumstick, mirroring the placement of the first weight of the first modified drumstick; testing the first modified drumstick and the second modified drumstick together on drums to determine if the weight added via the first weight and second weight is conducive to the training of the user; adding additional weights to the second mount of the first modified drumstick and the second mount of the second modified drumstick if more weight is desired by the user; and practicing drumming with the first modified drumstick and second modified drumstick.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A drumming training tool comprising:
a drumstick, said drumstick having a handle and a shaft;
mounts, said mounts present along said shaft; and
weights, said weights removably connected to said shaft via said mounts.

2. The training tool of claim 1, wherein there are a total of three mounts on said shaft.

3. The training tool of claim 1, wherein the mounts are disposed equidistant from one another.

4. The training tool of claim 1, wherein the mounts are disposed in a line.

5. The training tool of claim 1, wherein the weights are cylindrical.

6. The training tool of claim 1, wherein the weights are uniform in weight and dimension.

7. The training tool of claim 1, wherein each weight has a top and a bottom;
wherein said top is equipped with a mount; and
wherein said bottom is equipped with a peg.

8. The training tool of claim 2, wherein the mounts are disposed equidistant from one another.

9. The training tool of claim 2, wherein the mounts are disposed in a line.

10. The training tool of claim 2, wherein the weights are cylindrical.

11. The training tool of claim 3, wherein the weights are uniform in weight and dimension.

12. The training tool of claim 7, wherein the weights are uniform in weight and dimension.

13. A drumming training tool comprising:
a drumstick, said drumstick having a handle and a shaft;
mounts, said mounts present along said shaft;
weights, said weights removably connected to said shaft via said mounts;
wherein there are a total of three mounts on said shaft;
wherein the mounts are disposed equidistant from one another;
wherein the mounts are disposed in a line;
wherein the weights are cylindrical;
wherein the weights are uniform in weight and dimension;
wherein each weight has a top and a bottom;
wherein said top is equipped with a mount; and
wherein said bottom is equipped with a peg.

14. A method for gaining proficiency in drumming on a drum with drumsticks by a user comprising:
grasping a first modified drumstick, the first modified drumstick equipped with a first mount, a second mount, and a third mount, each of which facilitate the attachment of weights;
attaching a first weight to the first mount of the first modified drumstick, thereby increasing the overall weight of the first modified drumstick;
grasping a second modified drumstick, the second modified drumstick being identical to the first modified drumstick, similarly having a first mount, second mount and third mount to facilitate the attachment of weights;
attaching a second weight to the first mount of the second modified drumstick, mirroring the placement of the first weight of the first modified drumstick;
testing the first modified drumstick and the second modified drumstick together on drums to determine if the weight added via the first weight and second weight is conducive to the training of the user;
adding additional weights to the second mount of the first modified drumstick and the second mount of the second modified drumstick if more weight is desired by the user; and
practicing drumming with the first modified drumstick and second modified drumstick.

15. The method of claim 14, further comprising:
removing the first weight from the first modified drumstick and the first weight from the second modified drumstick;
placing the first weight on the second mount of the first modified drumstick, changing the balance of the first modified drumstick; and
placing the first weight on the second mount of the second modified drumstick, changing the balance of the first modified drumstick.
